(19) United States
(12) Patent Application Publication
(10) Pub. No.: US 2007/0261880 A1
(43) Pub. Date: Nov. 15, 2007

(54) CABLE GRIPPING DEVICE FOR A CABLE CLOSURE OR TERMINAL

(75) Inventors: Larry R. Cox, Austin, TX (US); Dean C. Krenz, Austin, TX (US); John P. Lammers, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/747,429

(22) Filed: May 11, 2007

Related U.S. Application Data
(60) Provisional application No. 60/747,007, filed on May 11, 2006.

(51) Int. Cl. H01R 4/70

(52) U.S. Cl. 174/138 F

(57) ABSTRACT

A telecommunications enclosure for housing lines of a telecommunications cable. The telecommunications cable includes a sheath surrounding the telecommunications lines. The enclosure includes a housing for retaining telecommunication lines therein, the housing including at least one inlet/outlet port to receive a telecommunications cable. The enclosure further includes a cable gripping device disposed in the housing. The cable gripping device includes a cable clamp and a high friction gripping surface. In one aspect, the high friction gripping surface includes a flexible abrasive material that surrounds a substantial portion of a perimeter of the telecommunications cable and is disposed between the cable sheath and the cable clamp. In other aspects, the high friction gripping surface comprises an integrally formed roughened inner band surface portion that includes a plurality of sharp protrusions. The cable gripping device can secure the cable against a pulling force of at least 100 lbs.

### CROSS REFERENCE TO RELATED APPLICATION

This application claims the benefit of U.S. Provisional Patent Application No. 60/747,007, filed May 11, 2006, the disclosure of which is incorporated by reference herein in its entirety.

### THE FIELD OF THE INVENTION

The present invention generally relates to a cable gripping device for a cable closure or terminal.

### BACKGROUND OF THE INVENTION

Telecommunication networks based on telecommunications lines having copper and/or optical fiber cables are well known. As telecommunication cables are routed across networks, it is necessary to periodically open the cable, splice to an end of a cable, and/or splice or tap into the cable so that data may be distributed to “branches” of the network. The branches may be further distributed until the network reaches individual homes, businesses, offices, and so on. The distributed lines are often referred to as drop lines or distribution lines.

Telecommunications closures, such as splice closures or terminals, are commonplace for copper cable and optical fiber splices in telecommunication networks. Telecommunications cables are supplied in many configurations and may be of composite constructions which include both optical and electrical conductors. Each of these cables, however, includes at least three functional elements, an outer sheath construction surrounding the conductors, some structure to withstand cable tension during or after installation, and multiple optical fibers/copper wires. Optionally, a metallic shield, rodent protection, multiple sheath layers, hydroscopic filling compound, multiple dielectric strands, and the like may be provided. At each access location where it is necessary to remove a portion of the cable sheath, it is necessary to protect the optical fibers/electrical conductors by a splice closure which restores mechanical and environmental protection for the cable. The closure protects the optical fibers/copper cables from breakage or bend damage which would, e.g., induce attenuation loss, cross talk, shorting, or signal interruption.

### SUMMARY OF THE INVENTION

A first aspect of the invention described herein provides a telecommunications enclosure for housing lines of a telecommunications cable. The telecommunications cable includes a sheath surrounding the telecommunications lines. The enclosure includes a housing for retaining telecommunication lines therein, the housing including at least one inlet/outlet port to receive a telecommunications cable. The enclosure further includes a cable gripping device disposed in the housing. The cable gripping device includes a cable clamp and a flexible abrasive material, where the cable clamp secures the cable to the housing and where the flexible abrasive material surrounds a substantial portion of a perimeter of the telecommunications cable and is disposed between the cable sheath and the cable clamp.

In one aspect, the cable gripping device further includes a strain relief bracket engageable with the housing. The cable clamp secures the cable to the strain relief bracket, and the flexible abrasive material surrounds a substantial portion of a perimeter of the telecommunications cable and is disposed between the cable sheath and the cable clamp.

In another aspect, a telecommunications enclosure for housing lines of a telecommunications cable having a sheath surrounding the telecommunications lines includes a housing for retaining the telecommunication lines therein, where the housing includes at least one inlet/outlet port to receive a telecommunications cable. The enclosure also includes a cable gripping device disposed in the housing, where the cable gripping device includes a cable clamp having a high friction, gripping surface disposed on an inner surface of the cable clamp.

In one aspect, the high friction, gripping surface comprises a roughened inner band surface portion that includes a plurality of sharp protrusions configured to shallowly penetrate a substantial surface area of the sheath of the cable that is surrounded by the cable clamp. In another aspect, the high friction, gripping surface is disposed on an extended band portion and includes a roughened inner surface portion that comprises a plurality of sharp protrusions, where the extended band portion is disposed between an outer band of the cable clamp and the cable being received in the housing.

In another aspect, a cable gripping device for gripping a telecommunications cable having a sheath surrounding the telecommunications lines comprises a cable clamp having a drive screw and a metal band, the metal band including a high friction, gripping surface disposed on an inner surface thereof to shallowly penetrate a substantial surface area of the sheath of the cable that is surrounded by the cable clamp.

The cable gripping device can secure the cable against a pulling force of at least 100 lbs.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1 is an isometric view of a telecommunications closure.

FIG. 2 is a schematic top view of the base portion of the telecommunications closure of FIG. 1 that includes an exemplary gripping device according to an embodiment of the present invention.

FIG. 3 is an exploded view of an exemplary gripping device according to an embodiment of the present invention.

FIG. 4 is a schematic view of an exemplary gripping device securing a cable according to an embodiment of the present invention.

FIGS. 5A and 5B are isometric views of an exemplary cable clamp according to another embodiment of the present invention.

FIG. 6 is an isometric view of another exemplary cable clamp according to another embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DESCRIPTION OF THE PREFERRED EMBODIMENTS

A cable gripping device for a cable closure or terminal in a telecommunications network is described herein. In particular, in one aspect, a flexible abrasive material, such as a cloth-backed abrasive, can be disposed in a cable clamp to provide a high friction, gripping surface on the outside diameter of a cable sheath being retained in the closure. Alternatively, the cable clamp can include an integral roughened inner surface that includes a plurality of burrs or sharp protrusions that can grip the cable by penetrating a substantial surface area of the sheath of the cable being retained. The gripping action provides an anchor point to prevent relative movement between the anchored ends at the entrance and exit ports of a telecommunication closure. More preferably, the gripping action can help the clamped cable to withstand an axial tensile load (or pulling force) of about at least 100 lbs.

The exemplary telecommunications closure described herein is a splice closure, such as is described in U.S. Pat. No. 4,805,979 (incorporated by reference herein in its entirety). As would be understood by one of ordinary skill in the art given the present description, the gripping device of the exemplary embodiments may be utilized with other types of closures and terminals. For example, the gripping device of the exemplary embodiments can be utilized with a fiber optic splice case, such as the 2178-XSB model, available from 3M Company, St. Paul, Minn.

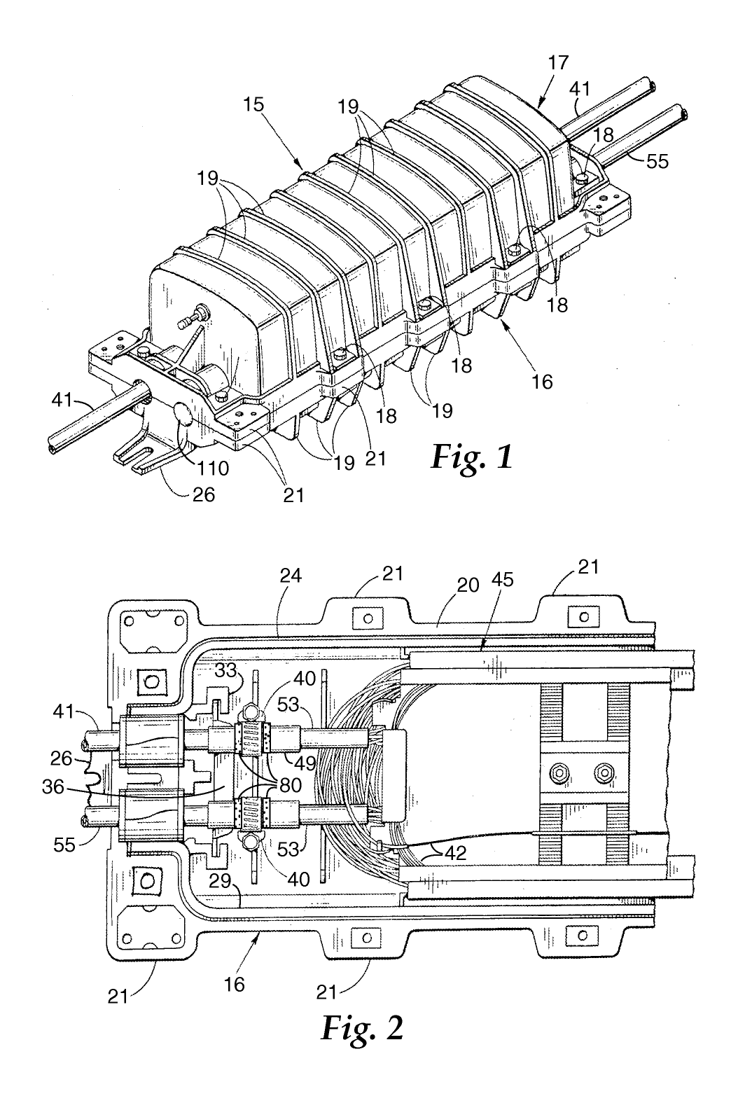

FIG. 1 shows an exemplary telecommunications closure 15 that comprises a base member 16 and a cover 17. FIG. 2 shows the base member 16 in further detail.

The base member and cover can be shell-like and have mating surfaces which are secured together by fastening members in the form of bolts 18 positioned in peripherally spaced relation about the cover and base. Other fastening members can also be utilized. The cover and base can be formed with rib members 19 which extend over the surface thereof to strengthen the molded parts. The base 16 can be generally rectangular in shape and molded from a rigid thermoplastic material which is resistant to heat, pressure, weathering and environmental hazards. An example of such a material is a filled or unfilled polypropylene, polyethylene, polyester or blended polyester. Formed around the surface 20 of the base and mating surface of the cover is a plurality of peripherally extending projections 21 in each of which can be placed an insert which receives a bolt 18 to hold the mating surface of the cover against the surface 20 of the base.

A plurality of channels can be formed in the surface 20 of the base 16 defining a sealing channel 24 which will receive a sealing strip or cord formed of mastic sealant material or a preformed rubber or silicone gasket to provide a seal between the surfaces. Suitable gasket materials may include, for example, elastomeric and polymeric materials, such as thermoplastic elastomers, vulcanite rubbers, polyurethane foams, reactive and non-reactive polymers, silicones, EPDMs, and soft plastics, to name a few. Material selection will depend upon factors including, but not limited to, chemical exposure conditions, environmental exposure conditions including temperature and humidity conditions, and flame-retardancy requirements, to name a few.

A plurality of arcuate walls can also be formed in the surface 20 and can include corrugations which are formed to receive a cable and define an inlet or outlet port 110 for receiving the cables into the chamber formed within the base and cover. The cable 41 extending through a port formed by the arcuate walls can be wrapped with a sealing tape formed of a mastic material to assure a hermetic seal about the cable within the port. Alternatively, in an exemplary embodiment, the cable can be inserted through a rubber grommet material (e.g., an elastomeric grommet surrounded by a rigid sleeve) such as is described in U.S. Pat. No. 7,186,929 (incorporated by reference herein in its entirety).

A split washer having an inside diameter to receive the cable and an outside diameter to fit within a corrugation in the opposed walls at the inlet/outlet port for the cables can be placed at each end of the sealing tape wrapped on the cable. Small channels can be formed in the portion of the wall 20 between the arcuate walls to complete the channel to seal the chamber. At each end of the base 16 can be formed a mounting bracket 26 for mounting the closure member to another structure, if desired. Holes can also be provided through the corners for aerial strand mountings.

FIGS. 1 and 2 show two cable inlet/outlet ports 110 for cables. As would be understood by one of ordinary skill in the art given the present description, closure 15 can include one, two, three, or more cable inlet/outlet ports.

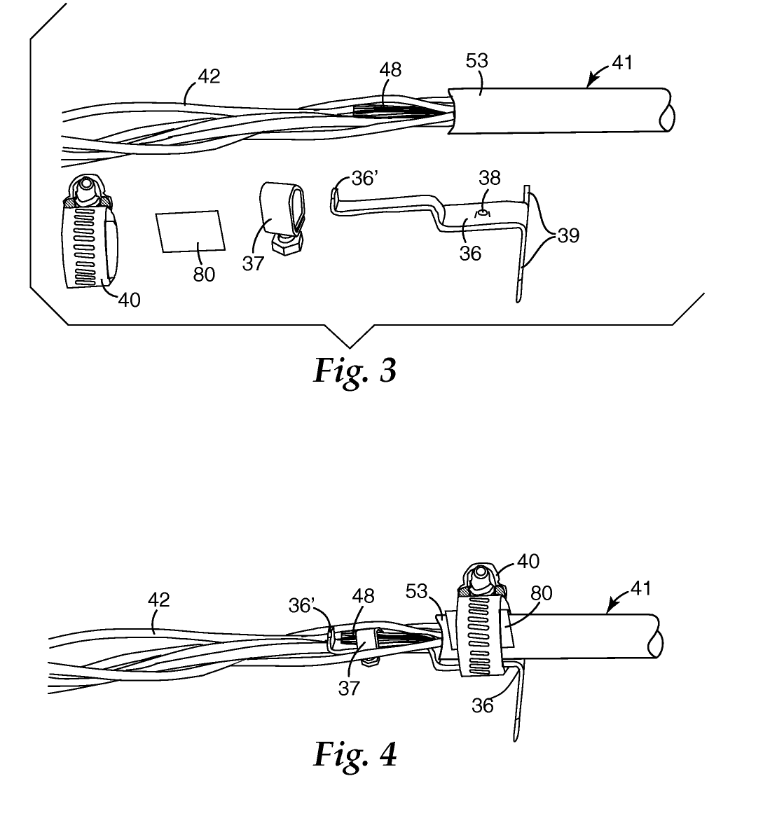

The base 16 can be formed with a recessed interior defined by vertical side walls 29 and end walls. One or more sets of brackets 33 can be provided integral with the end walls. In this exemplary closure, the brackets 33 can be formed with vertically disposed slots, to receive and engage with engaging portions 39 of one or more strain relief brackets 36 (see e.g. FIG. 3). The strain relief brackets 36 can be stamped from metal sheets and can comprise plate-like end members or engaging portions which engage with the slots to position the brackets 36.

The cables 41, 55 can each have a strength member 48 (see e.g., FIGS. 3 and 4) and a protective sheath 53. The cables may also have an additional shield which is generally metallic to provide an electrical shield and ground and also an armor covering for protecting the cable and the optical fibers/wires 42, where fibers can be further protected by buffer tubes. Covering the shield can be an outer layer of insulating material forming the sheath 53 for the cable. Further, optionally, a pressure sensitive adhesive coated rubber tape 49 can be wrapped about the cable sheath 53.

Cable 41, 55 can be prepared by removing the sheath 53 to expose the strength member(s) 48, the shielding, and the optical fibers/wires 42 contained therein that are to be spliced or further distributed. As shown in FIGS. 3 and 4, the strain relief brackets 36 can extend in an axial direction with cable 41. During installation, the strength member(s) 48 can be trimmed and affixed securely to an anchor portion 36′ of the bracket 36 via a fastening device 37. Alternatively, strength member(s) 48 can be anchored to a separate structure formed within closure 16. The strain relief bracket 36 shown in FIGS. 3 and 4 has a single anchor portion, but it would be understood by one of ordinary skill in the art given the present description that the bracket may have more than one anchor portion or member to accommodate multiple strength members.

The remaining fibers/wires 42 can be distributed/held within closure 15 by, e.g., mechanisms such as restraining members 45, which can be formed with inwardly projecting overhanging lips to maintain the loops of fiber optic buffer tubes/wires 44 in the base after the same have been generally formed in successive loops and placed within the base beneath the lips of the retaining members 45.

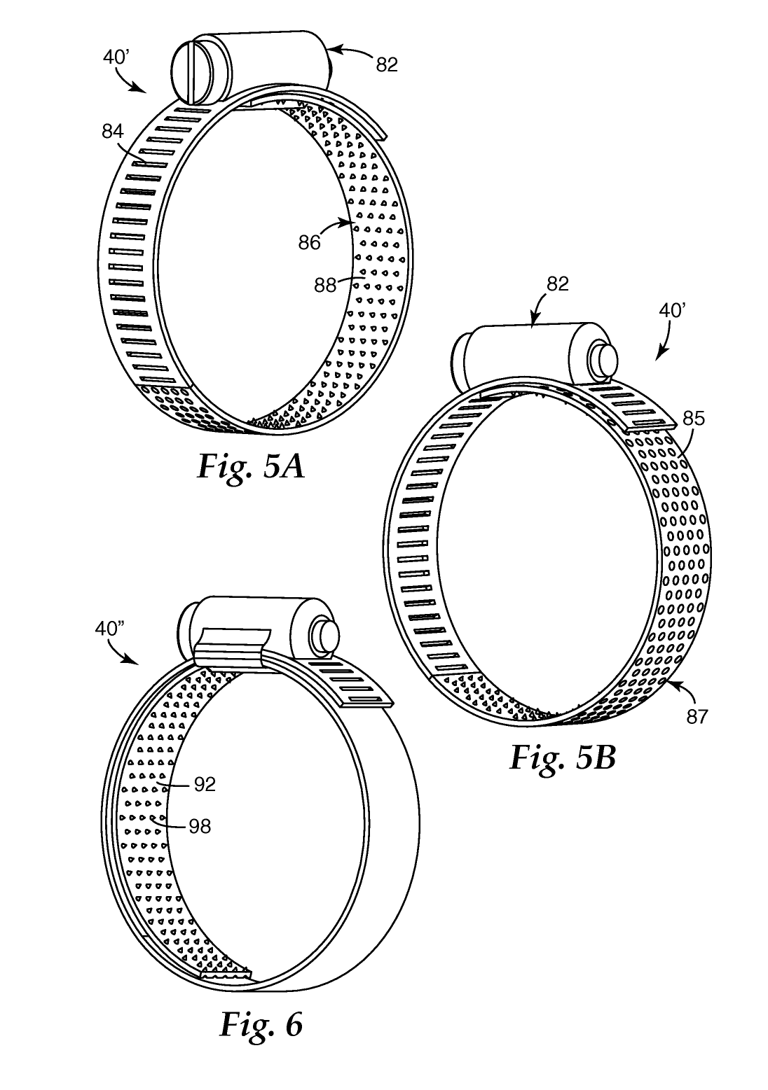

According to an exemplary embodiment, closure 15 further includes a cable gripping device. In one aspect, the cable gripping device comprises a cable clamp(s) 40 that is engageable with the strain relief bracket 36 to secure cables 41, 55 in the closure 15. The cable gripping device further includes a high friction, gripping surface to provide additional gripping action. In one exemplary aspect, a flexible abrasive material 80 is provided that is disposable between the cable clamp and the sheath 53 of the cable 41. Alternatively, the cable clamp 40 can be engageable with a structure different from the strain relief bracket, such as an integrally molded structure of the base 16 formed at or near one or more of the inlet/outlet ports to secure cables 41, 55. In a further alternative, the cable gripping device includes a cable clamp with a band having an integral roughened inner surface that includes a plurality of burrs or sharp protrusions (see FIGS. 5A-5B and 6). In yet another alternative aspect, a shim that includes a plurality of burrs or sharp protrusions can be fastened to the inner surface of the clamp band.

Preferably, one or more cable clamps 40 can be positioned about each cable 41 and 55, forming a strain relief structure to restrict the movement of the cables axially into or out of the closure 15 or base 16. In one aspect, as is shown in FIGS. 3 and 4, the cable gripping device further includes a flexible abrasive material 80 disposed between the cable sheath 53 and the clamp 40, where the abrasive side of the flexible abrasive material contacts the cable sheath. In exemplary embodiments, the flexible abrasive material can be selected from cloth-backed sandpaper, paper-backed sandpaper, a polymer-backed abrasive, a foil-backed abrasive, and a metal tape having an abrasive side. The flexible abrasive material is applied to the outer sheath 53 of the cable, where the flexible abrasive material can be wrapped about a substantial portion of the cable perimeter (e.g., from about one-third to about one-half to about three-fourths, or greater, about the perimeter).

The cable clamp 40 is preferably an adjustable clamp that can accommodate a range of cable outer diameters. For example, as is shown in FIGS. 3 and 4, the cable clamp can be a screw-type hose clamp that is disposed about cable sheath 53, abrasive material 80, and strain relief bracket 36. For example, a flexible abrasive material having a length sufficient to surround a substantial portion of the perimeter of the cable and a width of about 0.5 inch, 1.5 inches, or more can be utilized. The abrasive material can dig into a shallow portion of the sheath 53 to provide a substantially uniform gripping area by providing a plurality of structures that can each engage the cable sheath. As the abrasive material penetrates a relatively shallow depth of the cable sheath 53, possible damage to a cable shielding layer, the sheath itself, or the underlying fibers/copper cables can be reduced or eliminated.

Optionally, additional gripping of the sheath can be provided by one or more protrusions 38 formed in the strain relief brackets 36. The exemplary gripping device can also be used to secure cables of different wire/fiber count, different outer diameters, and different sheath constructions.

The cable clamp 40 can conform to almost any size cable and can be used on any type of cable including fiber optic, copper, and aluminum cable. The abrasive portion of the flexible abrasive material is preferably formed from coated/bonded/molded-in particles or features that create a high coefficient of friction when placed in contact with the cable sheath. An exemplary cloth-backed abrasive is a standard grit abrasive (50, 80, or other grit) available from 3M Company, St. Paul, Minn. (sold under the trade name—3M™ Utility Cloth). No special tools are required for field installation. Also, the compact size provides for installation in tightly congested areas. The flexible abrasive material 80 is preferably non-corrosive and non-conductive. Abrasive grit size can be selected according to cable anchoring requirements. Grit size can also be tailored to the type of sheath materials 53 being used. Very hard sheath materials may require aggressive, deeply penetrating grits, while softer sheath materials can operate with finer grits. Also, anchor pull-out forces can be used to select the degree of abrasive wrap around the cable in terms of wrap area.

In a preferred embodiment, cable clamp 40 can be a conventional hose clamp. Alternatively, cable clamp 40 can comprise a metal band or a round clamp having of two semi-circular halves, and containing one or more bolts for applying clamping pressure. In a further alternative, a circular clamp can be utilized, where the circular clamp can be made of a spring material which has a smaller inside diameter than the sheath, such that when the clamp is placed over the flexible abrasive 80 covering the sheath 53, spring tension can provide a circumferential force.

In an alternative aspect, as shown in FIGS. 5A and 5B, a cable clamp 40′ can include a band 84, preferably a malleable metal, having a plurality slots that engage a drive screw 82 (also referred to as a worm gear) that is utilized to adjust the band diameter. In this exemplary aspect, the band 84 includes a high friction, gripping surface. The high friction, gripping surface comprises an integral roughened inner surface portion 86 that includes a plurality of burrs or sharp protrusions 88 (preferably at least a dozen or more small burrs spaced randomly or uniformly about the inner surface of the band). The burrs or sharp protrusions 88 have sharp edges that can dig into or penetrate at a shallow depth a substantial surface area of the sheath 53 of the cable being retained by the clamp 40′. Preferably, the penetration depth does not exceed the thickness of the cable sheath.

In one aspect, the burrs or sharp protrusions 88 can be formed by a stamping process, preferably a high speed stamping process performed at the factory, where the stamp is pressed against outer band surface portion 85 (see FIG. 5B) to create a dimple pattern 87 on the outer band surface portion 85 and a burr pattern on the inner band surface portion 86. In a preferred aspect, a substantial portion of the circumference of the sheath of the cable being surrounded by the cable clamp (i.e., preferably at least about 33%, more preferably about 50% or more) is engaged by the array of burrs 88. Also, the dimple pattern 87 may include closed and/or open structures.

In another alternative aspect, as shown in FIG. 6, a cable clamp 40″ can include a malleable metal band 92 with a high friction, gripping surface that includes an extended band portion 98 having a roughened inner surface portion that comprises a plurality of burrs or sharp protrusions. The extended band portion 98 is disposed between the outer band of the cable clamp and the cable being gripped. The extended band portion can be configured to surround and engage a suitable portion of the sheath of the cable being retained by the clamp 40″. In one aspect, the extended band portion 98 is an integral part of the band of the cable clamp. Alternatively, the extended band portion 98 comprises a shim that is fastened to the inner surface of the band 92 by small clipping ears that extend from the corners of the shim. In a further alternative, the extended band portion 98 comprises a shim that attaches to the drive 82.

In a first experiment, a cable gripping device, similar to that shown in FIGS. 3 and 4, secured a cable while undergoing a 100 lbs. axial pull for 70 hours at room temperature. The example cable was a shielded Corning telecommunications cable having 72 optical fibers and an outer diameter of about 0.55 inches. The cable gripping device included a strain relief bracket having a circular protrusion formed on an anchor portion. In this experiment, the strength member of the cable was not secured to an anchor portion of the strain relief bracket. In addition, a cable clamp was tightened about the fiber cable, where a (about) 1.0″ wide flexible abrasive material (here, a P-80 (80 grit) 241-D 3M™ Utility Cloth) was interposed between the cable sheath and the cable clamp. The flexible abrasive material surrounded about ¾ of the perimeter of the cable. A 100 lbs. test weight was applied to the cable sheath to provide a pulling force. After 1 hour, the cable was axially displaced about 0.200″. After 70 hours, no additional displacement was observed.

In a second experiment, a cable gripping device, similar to that shown in FIGS. 3 and 4, secured a cable while undergoing a 100 lbs. axial pull for 24 hours at room temperature. The example cable was a non-shielded Pirelli telecommunications cable having 144 optical fibers and an outer diameter of about 0.69 inches. The cable gripping device included a strain relief bracket having a circular protrusion formed on an anchor portion. In this experiment, the strength member of the cable was not secured to an anchor portion of the strain relief bracket. In addition, a cable clamp was tightened about the fiber cable, where a (about) 1.0″ wide flexible abrasive material (here, a P-80 (80 grit) 241-D 3M™ Utility Cloth) was interposed between the cable sheath and the cable clamp. The flexible abrasive material surrounded about ¾ of the perimeter of the cable. A 100 lbs. test weight was applied to the cable sheath to provide a pulling force. After 1 hour, the cable was axially displaced about 0.125″. After 24 hours, no additional displacement was observed.

In a third experiment, a cable gripping device secured a cable while undergoing a 100 lbs. axial pull for 24 hours at about 104° F. The example cable was a Pirelli cable having 6 optical fibers and an outer diameter of about 0.48 inches. The cable gripping device included a strain relief bracket having a circular protrusion formed on an anchor portion, similar to that shown in FIGS. 3 and 4 (the strength member of the cable was not secured). In addition, a cable clamp was tightened about the fiber cable, where (about) 1.0″ wide flexible abrasive material (here, a P-80 (80 grit) 241-D 3M™ Utility Cloth) was interposed between the cable sheath and the cable clamp. The flexible abrasive material surrounded about ¾ of the perimeter of the cable. A 100 lbs. test weight was applied to the cable sheath. After 1 hour, the cable was axially displaced about 0.20″. After 24 hours, no additional displacement was observed.

The exemplary embodiments provide a relatively straightforward mechanism to prevent cable pull-out under heavy loads (e.g., about 100 lbs. or more). The cable gripping device can be utilized to work on a variety of different cable diameters and sheath materials. In addition, the shallow penetration of the abrasive/sharp burr material reduces the likelihood of damage to the underlying fibers or wires. Moreover, using a cable clamp having an integral roughened inner surface that includes a plurality of burrs, additional elements and special tools are not required.

Although specific embodiments have been illustrated and described herein for purposes of description of the preferred embodiment, it will be appreciated by those of ordinary skill in the art that a wide variety of alternate or equivalent implementations may be substituted for the specific embodiments shown and described without departing from the scope of the present invention. Those with skill in the art will readily appreciate that the present invention may be implemented in a very wide variety of embodiments. This application is intended to cover any adaptations or variations of the embodiments discussed herein. Therefore, it is manifestly intended that this invention be limited only by the claims and the equivalents thereof.

What is claimed is:

1. A telecommunications enclosure for housing lines of a telecommunications cable, the telecommunications cable having a sheath surrounding the telecommunications lines, comprising:
a housing for retaining telecommunication lines therein, the housing including at least one inlet/outlet port to receive a telecommunications cable; and
a cable gripping device disposed in the housing, wherein the cable gripping device includes a cable clamp and a flexible abrasive material, wherein the cable clamp secures the cable to the housing and wherein the flexible abrasive material surrounds a substantial portion of a perimeter of the telecommunications cable and is disposed between the cable sheath and the cable clamp.

2. The telecommunications enclosure of claim 1, wherein the flexible abrasive material comprises one of a cloth-backed abrasive material, a paper-backed abrasive material, a polymer-backed abrasive material, and a metal-backed abrasive material.

3. The telecommunications enclosure of claim 1, wherein the cable gripping device further includes a strain relief bracket engageable within the housing, wherein the cable clamp secures the cable to the strain relief bracket.

4. The telecommunications enclosure of claim 3, wherein the cable includes a cable strength member, wherein the cable strength member is anchored to a portion of the strain relief bracket via a fastening mechanism.

5. The telecommunications enclosure of claim 2, wherein the flexible abrasive material comprises a surface having a plurality of structures engageable with the cable sheath sufficient to provide a substantially uniform gripping surface.

6. A telecommunications enclosure for housing lines of a telecommunications cable, the telecommunications cable having a sheath surrounding the telecommunications lines, comprising:
a housing for retaining telecommunication lines therein, the housing including at least one inlet/outlet port to receive a telecommunications cable; and
a cable gripping device disposed in the housing, wherein the cable gripping device includes a cable clamp having a high friction, gripping surface disposed on an inner surface of the cable clamp.

7. The telecommunications enclosure of claim 6, wherein the high friction, gripping surface comprises an integrally formed roughened inner band surface portion that includes a plurality of sharp protrusions configured to penetrate a substantial surface area of the sheath of the cable that is surrounded by the cable clamp.

8. The telecommunications enclosure of claim 6, wherein the high friction, gripping surface is disposed on an extended band portion and includes a roughened inner surface portion that comprises a plurality of sharp protrusions, wherein the extended band portion is disposed between an outer band of the cable clamp and the cable being received in the housing.

9. The telecommunications enclosure of claim 6, wherein the cable gripping device further includes a strain relief bracket engageable within the housing, wherein the cable clamp secures the cable to the strain relief bracket.

10. The telecommunications enclosure of claim 9, wherein the cable includes a cable strength member that is anchored to a portion of the strain relief bracket via a fastening mechanism.

11. The telecommunications enclosure of claim 7, wherein the plurality of sharp protrusions provides a substantially uniform gripping surface.

12. The telecommunications enclosure of claim 8, wherein the extended band portion is fastened to a drive portion of the cable clamp.

13. The telecommunications enclosure of claim 6, wherein the high friction, gripping surface comprises a flexible abrasive material that surrounds a substantial portion of a perimeter of the telecommunications cable and is disposed between the cable sheath and the cable clamp.

14. The telecommunications enclosure of claim 6, wherein the high friction, gripping surface comprises a metal shim having a plurality of burs formed thereon that is fastenable to an inner surface of a band of the cable clamp that surrounds a substantial portion of a perimeter of the telecommunications cable and is disposed between the cable sheath and the cable clamp.

15. A cable gripping device for gripping a telecommunications cable, the telecommunications cable having a sheath surrounding the telecommunications lines, comprising:
a cable clamp having a drive screw and a metal band, the metal band including a high friction, gripping surface disposed on an inner surface thereof to shallowly penetrate a substantial surface area of the sheath of the cable that is surrounded by the cable clamp.

16. The cable gripping device of claim 15, wherein the high friction, gripping surface comprises an integrally formed roughened inner band surface portion that includes a plurality of sharp protrusions configured to shallowly penetrate a substantial surface area of the sheath of the cable that is surrounded by the cable clamp.

17. The cable gripping device of claim 15, wherein the high friction, gripping surface is disposed on an extended band portion and includes a roughened inner surface portion that comprises a plurality of sharp protrusions, wherein the extended band portion is disposed between an outer band of the cable clamp and the cable being received in the housing.
